(19) United States
(12) Patent Application Publication
(10) Pub. No.: US 2008/0292841 A1
(43) Pub. Date: Nov. 27, 2008

(54) Regenerative aramid honeycomb sandwich energy absorbing matrix and square tube supported honeycomb sandwich bridge

(76) Inventor: David Randall Williams, Baltimore, MD (US)

Correspondence Address: David R. Williams, 110 E 20th St. # 3, Baltimore, MD, 21218, US

(21) Appl. No.: 11/802,444

(22) Filed: May 23, 2007

(51) Int. Cl. B32B 3/12

(52) U.S. Cl. 428/116

(57) ABSTRACT

The function of the Regenerative Aramid Honeycomb Sandwich Energy Absorbing Matrix and Square
Square Tube Support Honeycomb Sandwich Bridge utilizes three separate matrixes of honeycomb to
Absorb and redirect impact forces. The first honeycomb matrix is open to absorb the initial forces of impact, between is the honeycomb sandwich separating the first matrix of honeycomb from the second matrix of honeycomb which functions as the secondary means of absorbtion and redirection again followed by honeycomb sandwich and the third matrix of honeycomb which is ⅓ smaller in diameter than the second which in turn is ⅓ smaller in diameter than the first. The second and third matrixes of honeycomb function as a cushion (much like bubble wrap) before the majority of energy reaches the honeycomb sandwich bridge and square tube supports, when impact forces are greater the bridge then absorbs that energy and the square tube supports provide additional absorbtion while providing a crush zone absorbing any remaining energy from impact.

### BACKGROUND OF THE INVENTION

Specifically developed utilizing previously patented engineering principles the REGENERATIVE ARAMID HONEYCOMB SANDWICH ENERGY ABSORBING MATRIX and SQUARE TUBE SUPPORTED HONEYCOMB of SANDWICH BRIDGE is composed of three layers of honeycomb of varying diameters largest at the front

Smallest at the rear between are two layers of honeycomb sandwich which are similar to the overall Design of the matrix, being 1/10 of a inch in depth in five layers within two of the five are honeycomb of the same depth. Each layer sandwich is ½ inch in depth while the matrix of honeycomb are 1 inch in depth. This combination will yield a superior means of energy absorbtion and dispersion while providing the unit a capability of withstanding exerted forces and the ability of endurance.

The bridge utilizes a similar approach being composed of a honeycomb sandwich but of rigid materials i.e. Kevlar, Carbon fiber, Aluminum, ect. The supports are square in form to provide additional absorbtion with the ability to fold upon severe impacts which are attached to a vehicles front and rear ends.

### SUMMARY

These elements combined with Aramid front and rear facias will provide a vehicle with the ability to

Withstand minor impacts of 7.5 mph benefitting consumers and the automotive insurance industry

Reducing the cost of replacement to a vehicles front or rear end and also furnishing a means of

Encountering and dispersing energy from severe impacts.

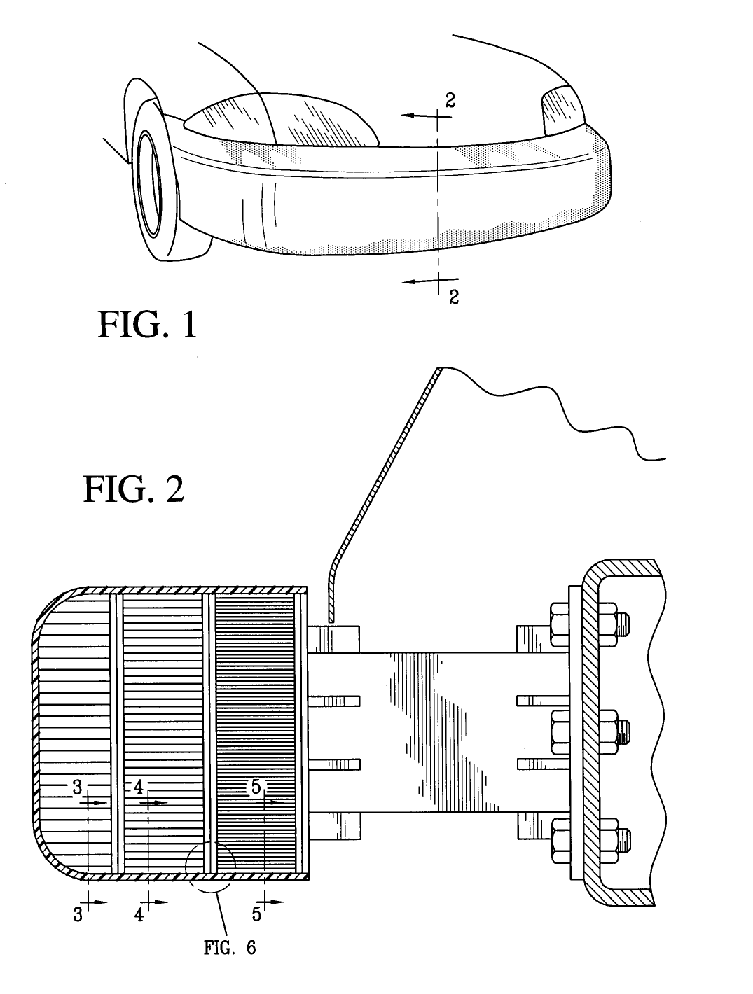

FIG. 1 Vehicle front end.

FIG. 2 Representation side profile of Regerative Aramid Honeycomb Sandwich Energy Asorbing Matrix and Square Tube Supported Honeycomb Sandwich Bridge.

FIG. 3 First matrix of honeycomb (large diameter)

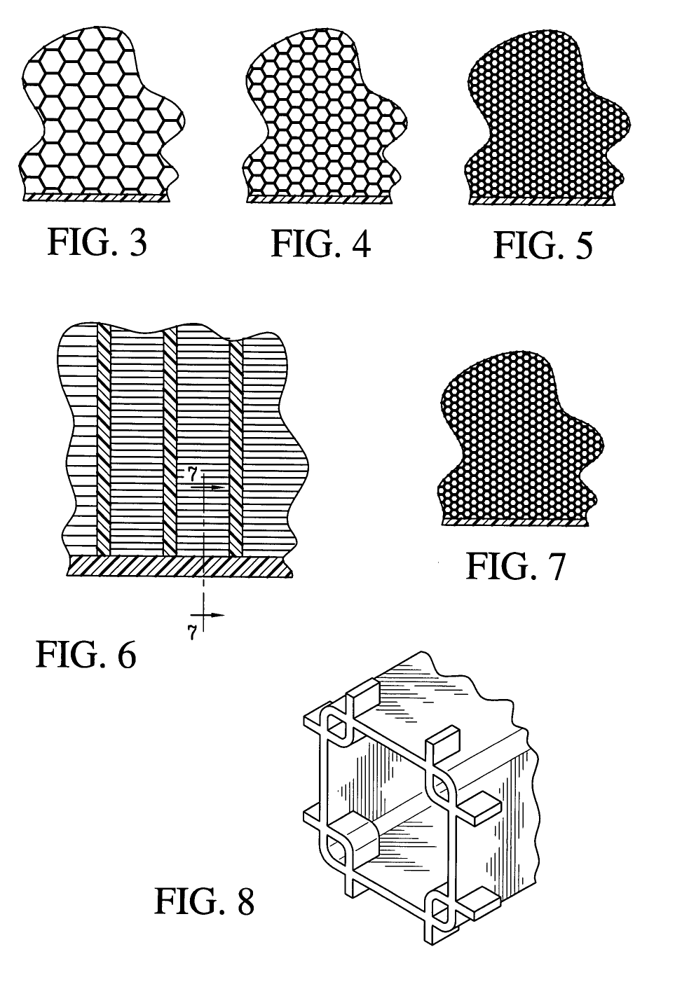

FIG. 4 Second matrix of honeycomb (smaller diameter)

FIG. 5 Third matrix of honeycomb (smallest diameter)

FIG. 6 Honeycomb sandwich layer.

FIG. 7 Honeycomb layer (smallest diameter)

FIG. 8 Square tube support with integrated stops.

1. I David Randall Williams, claim the Regenerative Aramid Honeycomb Sandwich Energy Absorbing Matrix
And Square tube supported Honeycomb Sandwich bridge as my invention.
